(19) United States
(12) Patent Application Publication
(10) Pub. No.: US 2013/0060588 A1
(43) Pub. Date: Mar. 7, 2013

(54) MODELING AND MONITORING A RELATIONSHIP WITH A CLIENT AND ASSESSING THE QUALITY OF THE RELATIONSHIP

(71) Applicants: Guruduth S. Banavar, Pelham Manor, NY (US); Suhas M. Bhide, Bangalore (IN); Sugata Ghosal, New Delhi (IN); Renuka R. Sindhgatta, Bangalore (IN)

(72) Inventors: Guruduth S. Banavar, Pelham Manor, NY (US); Suhas M. Bhide, Bangalore (IN); Sugata Ghosal, New Delhi (IN); Renuka R. Sindhgatta, Bangalore (IN)

(73) Assignee: INTERNATIONAL BUSINESS MACHINES CORPORATION, Armonk, NY (US)

(21) Appl. No.: 13/225,874

(22) Filed: Sep. 6, 2011

(51) Int. Cl. G06Q 10/00

(52) U.S. Cl. 705/7.11

(57) ABSTRACT

A method and system of managing a relationship between a provider and a client. A project model, organization model and stakeholder model are generated. Based on the project, organization and stakeholder models, factors that influence the relationship between the provider and the client are defined. The factors are evaluated by receiving results of data mining artifact(s) of the project, surveying the provider and/or client with a role-based survey, and capturing experiences provided by the provider and/or client. A status of the relationship is proactively monitored based on the evaluated factors. Based on historical information about the relationship and based on the evaluated factors, the status of the relationship between the provider and the client is assessed.

### TECHNICAL FIELD

The present invention relates to a data processing method and system for managing business relationships with clients, and more particularly to a technique for modeling, monitoring and assessing a relationship between a provider and a client.

### BACKGROUND

The quality of relationships between a service provider and clients plays a crucial role in the growth of the business of the service provider. In the information technology (IT) services industry, IT service providers have different types of projects with different contractual obligations and varied expectations with respect to quality and cost. The relationship between the IT service provider and the client depends on the aforementioned obligations and expectations and needs to be monitored to sustain the business of the service provider. The current mechanism of monitoring and assessing such relationships by is limited because it is reactive, provides only a single point of view, and follows a “one size fits all” approach by periodically having the client complete a generic client satisfaction survey. The health of each provider-client relationship is often assessed in a qualitative and subjective manner. With known relationship monitoring and assessment techniques, it is also difficult to identify the factors and particular aspects contributing to the improvement or deterioration of a relationship. Thus, there exists a need to overcome at least one of the preceding deficiencies and limitations of the related art.

### BRIEF SUMMARY

First embodiments of the present invention provide a method of managing a relationship between a provider and a client. The method comprises the steps of:

a computer generating a first model of one or more projects in which the provider is providing a service to the client, wherein the provider and the client are business entities;

the computer generating a second model of first levels of a first organizational structure of the provider and second levels of a second organizational structure of the client;

the computer generating a third model of a first set of stakeholders having respective roles in the provider, a second set of stakeholders having respective roles in the client, and interactions between the first set of stakeholders and the second set of stakeholders;

based on the first, second and third models, the computer defining factors that influence the relationship between the provider and the client;

the computer evaluating the factors by receiving results of mining data from one or more artifacts of the one or more projects, surveying the provider and/or client with a role-based survey, and capturing experiences provided by the provider and/or client; and

based on historical information about assessments of the relationship and based on the evaluated factors, the computer assessing a status of the relationship between the provider and the client.

A system, program product and a process for supporting computing infrastructure where the process provides at least one support service are also described and claimed herein, where the system, program product and process for supporting computing infrastructure correspond to the aforementioned method.

Second embodiments of the present invention provide a method of managing a relationship between a provider and a client. The method comprises the steps of:

a computer receiving attributes of one or more projects in which the provider is providing a service to the client;

the computer receiving attributes of the client and attributes of the provider;

the computer modeling the one or more projects based on the received attributes of the one or more projects;

the computer modeling an organization of the client and stakeholders associated with the client based on the received attributes of the client;

the computer modeling an organization of the provider and stakeholders associated with the provider based on the received attributes of the provider;

the computer modeling interactions among stakeholders within the client, among stakeholders within the provider, and among stakeholders across the organizations of the client and the provider;

the computer capturing information about factors that influence the relationship between the provider and the client;

the computer monitoring a status of the relationship based on the captured information;

the computer assessing the status of the relationship by applying a statistical technique to historical information about the relationship, wherein the historical information is based on the captured information about the factors that influence the relationship, and wherein the captured information includes data from stakeholders associated with the client and data from stakeholders associated with the provider; and repeating, in real time during a life of the one or more projects, the steps of capturing the information and monitoring the status of the relationship; and

the computer re-assessing the status of the relationship by applying the statistical technique to the historical information about the relationship and additional historical information about the relationship, wherein the additional historical information is based on the captured information resulting from the step of repeating the step of capturing the information.

Embodiments of the present invention provide a technique for modeling, proactively monitoring and assessing a relationship between a provider and a client so that specific aspects of the relationship between the provider and the client that need improvement are identified.

### BRIEF DESCRIPTION OF THE DRAWINGS

FIG. 1 is a block diagram of a system for modeling, monitoring and assessing a relationship between a provider and a client, in accordance with embodiments of the present invention.

FIG. 2 is a flowchart of a process of modeling, monitoring and assessing a relationship between a provider and a client, where the process is implemented in the system of FIG. 1, in accordance with embodiments of the present invention.

FIG. 3 is a sample view of a model of stakeholders of the provider and client whose relationship is modeled, monitored and assessed in the process of FIG. 2, in accordance with embodiments of the present invention.

FIG. 4 is a sample interface including a survey questionnaire for identifying and monitoring factors of the relationship being modeled, monitored and assessed in the process of FIG. 2, in accordance with embodiments of the present invention.

FIG. 5 is a sample interface including an experience capture form for identifying and monitoring factors of the relationship being modeled, monitored and assessed in the process of FIG. 2, in accordance with embodiments of the present invention.

FIG. 6 is a sample report about the quality of a relationship, where the report generated in the process of FIG. 2, in accordance with embodiments of the present invention

FIG. 7 is a block diagram of a computer system that is included in the system of FIG. 1 and that implements the process of FIG. 2, in accordance with embodiments of the present invention.

### DETAILED DESCRIPTION

### Overview

Embodiments of the present invention may provide a method and system for modeling client and service provider organizations, stakeholders in the client and service provider organizations, and projects in which the stakeholders participate. Based on the modeling, a relationship between the service provider and the client is defined. Multiple sources such as mining project artifacts, role-based surveys and feedback mechanisms (i.e., experience capture) are used to monitor the relationship between the service provider and the client. Statistical models are used to analyze and assess the health of the relationship.

In one embodiment, the aforementioned service provider provides information technology (IT) services to the client.

### System for Modeling, Monitoring and Assessing Provider-Client Relationships

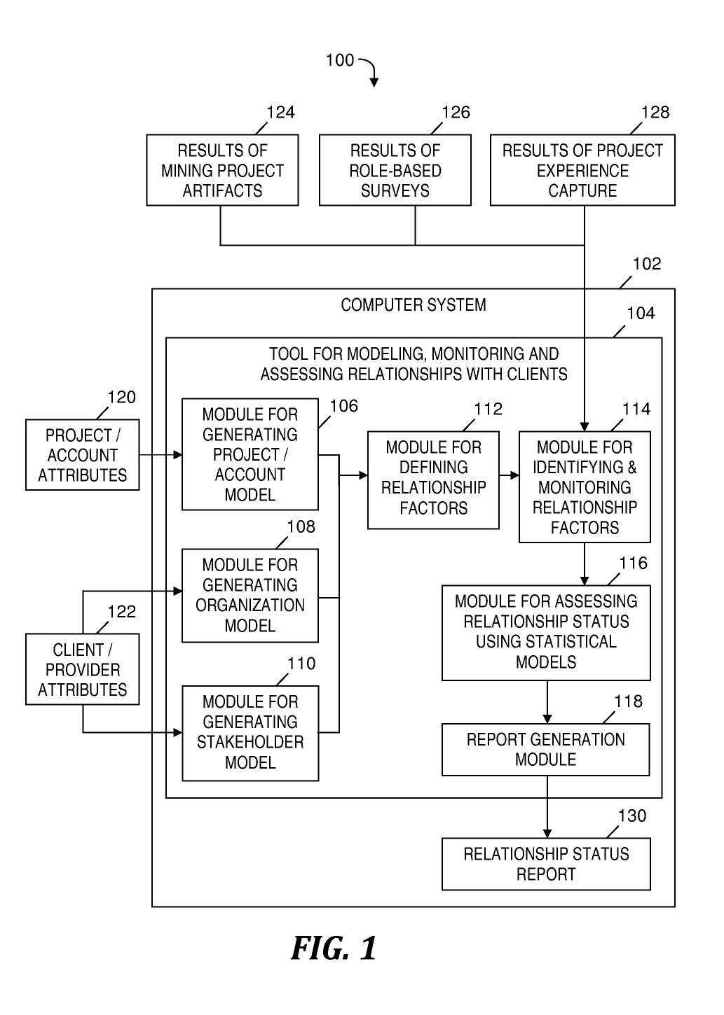

FIG. 1 is a block diagram of a system for modeling, monitoring and assessing a relationship between a provider and a client, in accordance with embodiments of the present invention. System 100 may include a computer system 102, which runs a software-based tool 104 for modeling, monitoring and assessing a relationship with a client. Tool 104 may include a module 106 for generating a project model or account model, a module 108 for generating an organization model, and module 110 for generating a stakeholder model. Further, tool 104 may include a module 112 for defining factors (a.k.a. relationship factors) of the relationship with the client and a module 114 for identifying and monitoring the relationship factors. Still further, tool 104 may include a module 116 for assessing a status of the relationship with the client using statistical models or techniques, and a module 118 for generating a report.

Module 106 for generating the project or account model receives project or account attributes 120, respectively. Module 108 for generating the organization model and module 110 for generating the stakeholder model receive attributes of the client and attributes of the provider.

Module 114 for identifying and monitoring relationship factors receives results 124 of data mining artifacts of the project modeled by module 106, results 126 of role-based survey(s) completed by the client and/or the provider, and results 128 of project experience capture (i.e., real-time, freeform feedback information collected from the client and/or provider). Experience capture may be performed at any time by stakeholders associated with the provider and/or stakeholders associated with the client.

Report generation module 118 generates a relationship status report 130 that indicates the status (i.e., health or quality) of the relationship with the client that is assessed by module 116.

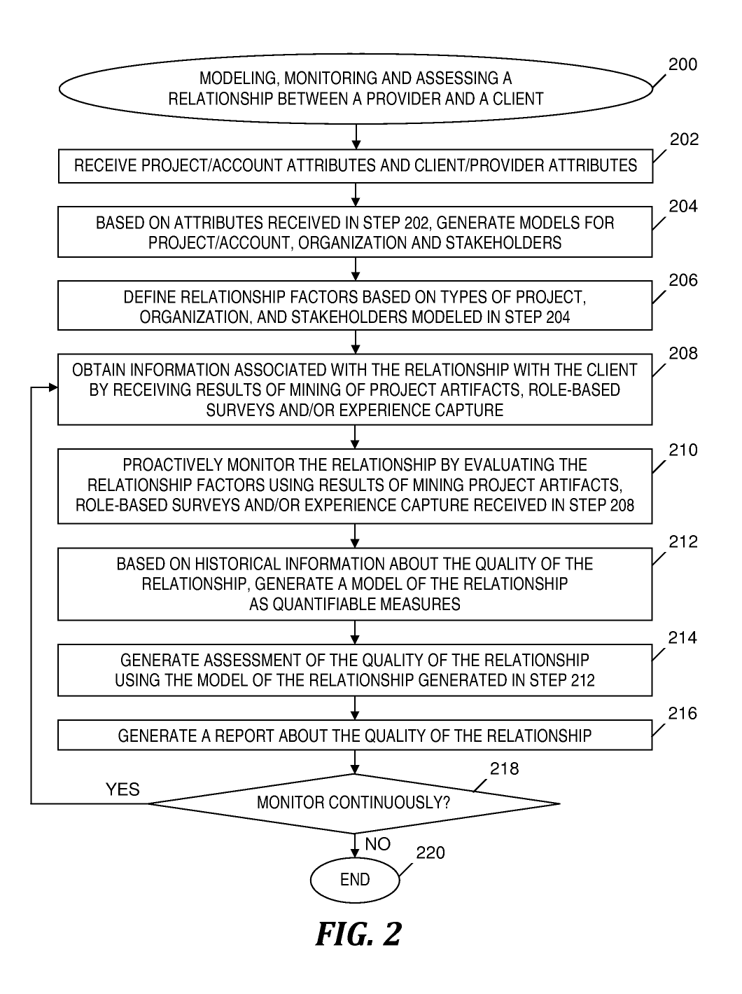

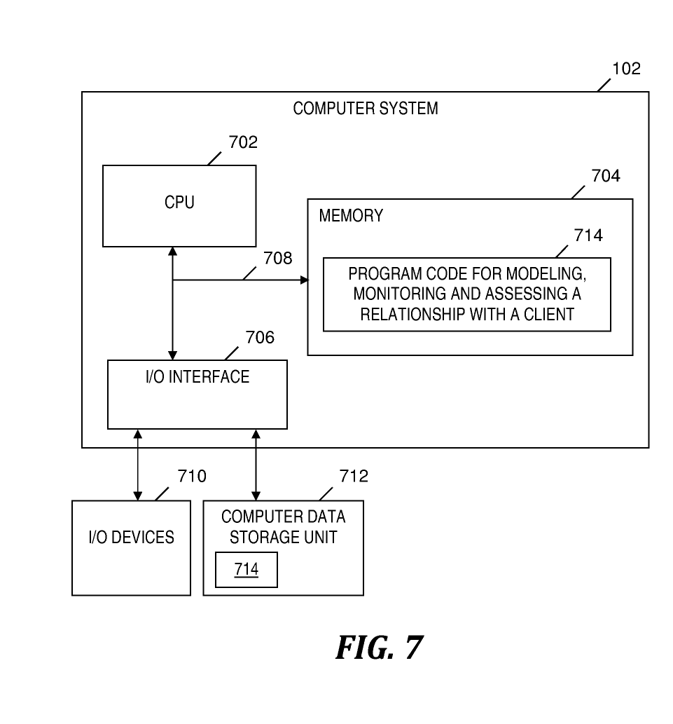

The functionality of the components of computer system 102 is further described below relative to FIG. 2 and FIG. 7.

### Process for Modeling, Monitoring and Assessing Provider-Client Relationships

FIG. 2 is a flowchart of a process of modeling, monitoring and assessing a relationship between a provider and a client, where the process is implemented in the system of FIG. 1, in accordance with embodiments of the present invention. The process of modeling, monitoring and assessing a relationship between a provider and a client who are engaged in one or more projects (i.e., accounts) begins at step 200. In step 202, tool 104 (see FIG. 1) receives attributes of the project(s) (i.e., project attributes), attributes of the provider (i.e., provider attributes) and attributes of the client (i.e., client attributes).

The project attributes received in step 202 include an indication of the type of project (e.g., high-level strategy project) and the contractual obligations based on the type of project.

Provider attributes received in step 202 include indications of the levels of the organizational structure of the provider and the roles of stakeholders (i.e., provider stakeholders) who are involved in the project and who are employed by or otherwise associated with the provider.

Client attributes received in step 202 include indications of the levels of the organizational structure of the client and the roles of stakeholders (i.e., client stakeholders) who are involved with the project and who are employed by or otherwise associated with the client. In one embodiment, the roles of the provider stakeholders map to the levels of the organizational structure of the provider, and the roles of the client stakeholders map to the levels of the organizational structure of the client.

In step 204, based on the attributes received in step 202, tool 104 (see FIG. 1) generates first, second and third models. The first model is an engagement model of the project(s) in which the provider and client are engaged. In one embodiment, the engagement model models the entire project, including the implementation of the project. The second model is an organization model that includes first levels of the organizational structure of the provider and further includes second levels of the organizational structure of the client. The third model is a stakeholder model that includes a first set of stakeholders having respective roles in the provider, a second set of stakeholders having respective roles in the client, details of interactions among the stakeholders in the provider, details of interactions among the stakeholders in the client, and details of interactions between stakeholders in the provider and stakeholders in the client (i.e., interactions between stakeholders within and across the provider and client organizations).

In step 206, based on the engagement, organization and stakeholder models generated in step 204, tool 104 (see FIG. 1) defines the factors (i.e., relationship factors) that influence the relationship between the provider and the client. Alternatively, a user of computer system 102 (see FIG. 1) defines the relationship factors and tool 104 (see FIG. 1) receives the user-defined relationship factors in step 206. Hereinafter, the relationship between the provider and the client (a.k.a. relationship with the client) is also referred to simply as “the relationship.” The relationship factors defined in step 206 are used to design interfaces for role-based surveys, data mining of project artifacts and experience capture, which are described below relative to step 208.

In one embodiment, the relationship factors defined in step 206 are categorized according to multiple levels of the organizational structures of the provider and client or according to multiple roles of stakeholders associated with the provider and client.

For example, each role of a stakeholder may indicate operational management, middle management or top management. The relationship factors in this example may be in three categories: (1) factors associated with the operational management (e.g., defect rate, project delivered on time and within budget, adherence to other milestones, timeliness of delivering on maintenance requests, and service level agreement (SLA) breaches); (2) factors associated with middle management (e.g., escalation management, milestone adherence, and response times); and (3) factors associated with top management (e.g., contractual flexibility and financial agreements).

In one embodiment, step 206 includes tool 104 (see FIG. 1) modeling the relationship based on the type of engagement (e.g., high-level strategy, etc.) and the stakeholders in the client organization and in the provider organization. Furthermore, tool 104 (see FIG. 1) classifies the stakeholders based on their roles and identifies the relationship factors for each role.

In step 208, tool 104 (see FIG. 1) obtains information about the relationship by receiving results of data mining of engagement repositories that include artifacts of the project (e.g., email repositories), results of role-based surveys completed by the provider and the client, and results of experience capture (i.e., feedback mechanism) that collect project-related experiences provided by the provider and/or the client. A role-based survey is a set of questions based on the different roles by which stakeholders are classified and/or based on the different organizational levels of stakeholders in an organization. Further, a role-based survey is based on whether the survey is designed to be completed by a provider stakeholder or by a client stakeholder. In one embodiment, a role-based survey is further based on the type(s) of the project(s) in which the provider and client are engaged.

An experience capture allows freeform entry by the client or provider stakeholder and is therefore not constrained by the set of questions of a role-based survey. Further, experience capture allows a client or provider stakeholder to enter project-related experiences entry at any time during the life cycle of the project.

In step 210, tool 104 (see FIG. 1) proactively monitors the relationship in real time during the life of the project by evaluating the relationship factors using the results of the data mining, role-based surveys and experience capture received in step 208.

In step 212, based on historical information about the quality (i.e., status) of the relationship, tool 104 (see FIG. 1) generates a model of the relationship as quantifiable measures. The generated model of the relationship may be based on the roles of the stakeholders and/or the type of the project. Tool 104 (see FIG. 1) may determine the historical information based on prior evaluations of the relationship factors that occurred prior to step 210, where the prior evaluations indicate a particular effect on the status of the relationship. Based on the prior evaluations and based on the evaluation of the relationship factors in step 210, tool 104 (see FIG. 1) may predict an effect on the status of the relationship that is likely to occur in the future.

The quantifiable measures in the generated model of the relationship may indicate, for example, that for a project of type T, a deficiency in relationship factor X is associated with a low (i.e., problematic) quality of a relationship, whereas for a project of type U, a deficiency in the same relationship factor X is not associated with a low quality of the relationship.

As another example, sample historical information including ratings of categories of relationship factors for a relationship with a client in an operational management level is shown in Table 1. Based on the historical information in Table 1 and using statistical techniques such as regression analysis, trust in the relationship may be evaluated. In the scenario illustrated in Table 1, factors categorized in Joint Action and Information Sharing are highly correlated to trust in the relationship.

TABLE 1

| | | | | Commu- | |
|---|---|---|---|---|---|
| | | Partic- | Joint | nication | Information |
| Date | Trust | ipation | Action | Quality | Sharing |
| June 2005 | 2.8 | 2 | 2 | 1 | 3 |
| December 2005 | 3.4 | 3 | 3 | 2 | 4 |
| June 2006 | 3.5 | 3 | 2 | 3 | 5 |
| December 2006 | 2.7 | 2 | 2 | 1 | 4 |
| June 2007 | 3.2 | 4 | 3 | 2 | 3 |
| December 2007 | 3.8 | 3 | 2 | 2 | 5 |
| March 2008 | 2.2 | 2 | 1 | 1 | 2 |
| September 2008 | 3.3 | 2 | 2 | 3 | 3 |
| December 2008 | 2.5 | 3 | 2 | 2 | 2 |
| April 2009 | 3.2 | 4 | 3 | 2 | 3 |
| August 2009 | 3.3 | 3 | 3 | 3 | 2 |

In step 214, tool 104 (see FIG. 1) generates an assessment of the quality of the relationship using the model of the relationship generated in step 212. In one embodiment, step 214 employs a statistical technique (e.g., regression analysis) based on the historical data to identify particular projects in which the relationship with a client is likely to be of a particular (e.g., low or high) quality based on an evaluation of particular relationship factors (e.g., an evaluation indicating that the relationship factors are deficient or not deficient).

For example, based on regression analysis of the historical information in Table 1, tool 104 (see FIG. 1) determines in step 214 an equation (1) for evaluating Trust, as presented below:

Trust=0.12*Participation+0.36*Joint Action+0.32*Communication Quality+0.36*Information Sharing (1)

Using equation (1) and based on results of role-based surveys, experience capture and data mining of project artifacts (i.e., information obtained in step 208), tool 104 (see FIG. 1) generates an assessment in step 214 by predicting the trust in the relationship. Subsequent to predicting the trust in the relationship, tool 104 (see FIG. 1) in step 214 may determine actions that may be taken to improve the predicted trust in the relationship.

In one embodiment, step 214 includes generating assessments of statuses of the relationship at multiple levels of the organizational structure of the provider and the client. In one embodiment, step 214 may include generating assessments of statuses of the relationships based on multiple roles, where each set of multiple sets of stakeholders have a corresponding role of the multiple roles.

In step 216, tool 104 (see FIG. 1) generates a report about the quality of the relationship, where the report indicates the assessment generated in step 214. The report may include ratings of relationship factors (or of different categories of relationship factors) over time and at different organizational levels (or for different stakeholder roles). The report may indicate key relationship factors that need to be well-maintained in order to ensure that the relationship is of high quality. In one embodiment, the report generated in step 216 indicates statuses of the relationship, where each status corresponds to a particular level of the organizational structure of the provider and client (e.g., operational management, middle management, or top management). The report may, for example, indicate that a first status of the relationship at one level of the organizational structure (e.g., operational management) is different from a second status of the relationship at another organizational level (e.g., middle management).

If tool 104 (see FIG. 1) determines in step 218 that the relationship is being monitored continuously, then the Yes branch of step 218 is taken and the process of FIG. 2 loops back to step 208 to monitor the relationship continuously based on real time information entered by the provider and the client. The real time information is subsequently received in the next iteration of step 208 as additional results of data mining project artifacts and/or additional results of experience capture. In one embodiment, in the next iteration of step 214, tool 104 (see FIG. 1) re-assesses the status of the relationship by applying the statistical technique to the historical information and to additional historical information about the relationship, where the additional historical information is based on the information obtained in the most recent performance of step 208.

If tool 104 (see FIG. 1) determines in step 218 that the relationship is not to be monitored continuously, then the No branch of step 218 is taken and the process of FIG. 2 ends at step 220.

### EXAMPLES

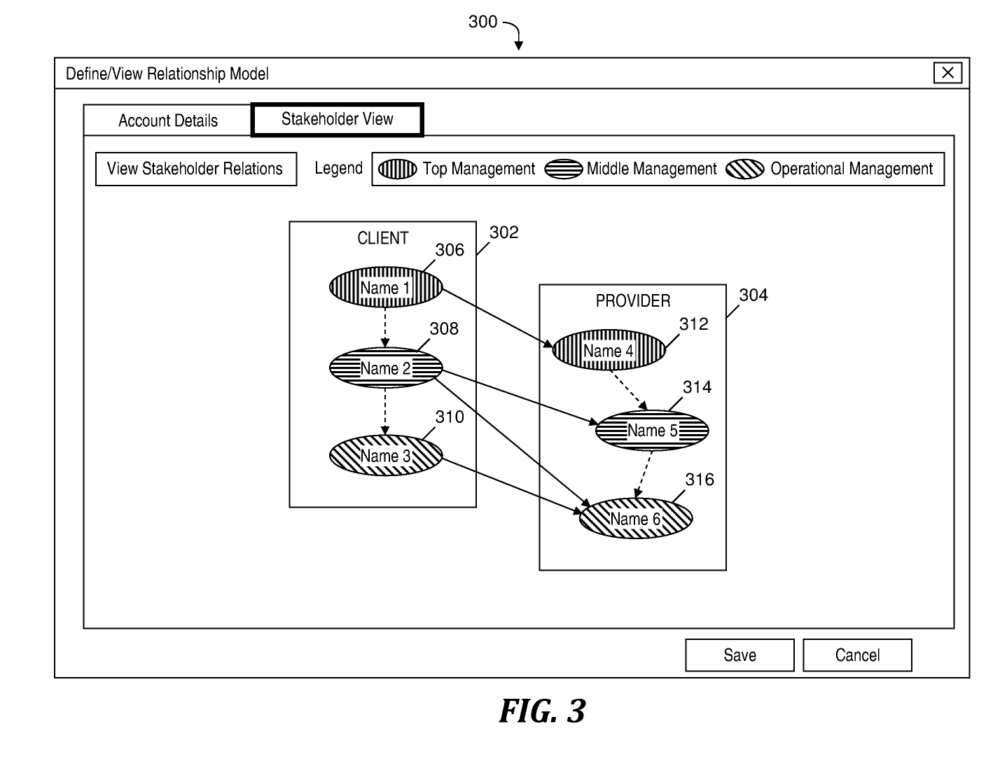

FIG. 3 is a sample view of a model of stakeholders of the provider and client whose relationship is modeled, monitored and assessed in the process of FIG. 2, in accordance with embodiments of the present invention. View 300 is provided by tool 104 (see FIG. 1) and includes solid arrows to indicate relationships between client stakeholders 302 and provider stakeholders 304. Client stakeholders 302 include stakeholders 306, 308 and 310 identified by Name 1, Name 2 and Name 3, respectively. Provider stakeholders 304 include stakeholders 312, 314 and 316 identified by Name 4, Name 5 and Name 6, respectively. There are relationships between: Name 1 and Name 4, Name 2 and Name 5, Name 2 and Name 6, and Name 3 and Name 6.

Relationships between stakeholders within the client organization or within the provider organization are represented by dashed arrows in FIG. 3.

Each oval representing a stakeholder is colored to indicate the level associated with the role of the stakeholder. Stakeholders 306 and 312 are represented by ovals colored red (i.e., indicated by the vertical line fill pattern in FIG. 3), which indicate that Name 1 and Name 4 have roles in Top Management. Further, stakeholders 308 and 314 are represented by ovals colored blue (i.e., indicated by the horizontal line fill pattern in FIG. 3), which indicate that Name 2 and Name 5 have roles in Middle Management. Still further, stakeholders 310 and 316 are represented by ovals colored green (i.e., indicated by the diagonal line fill pattern in FIG. 3), which indicate that Name 3 and Name 6 have roles in Operational Management.

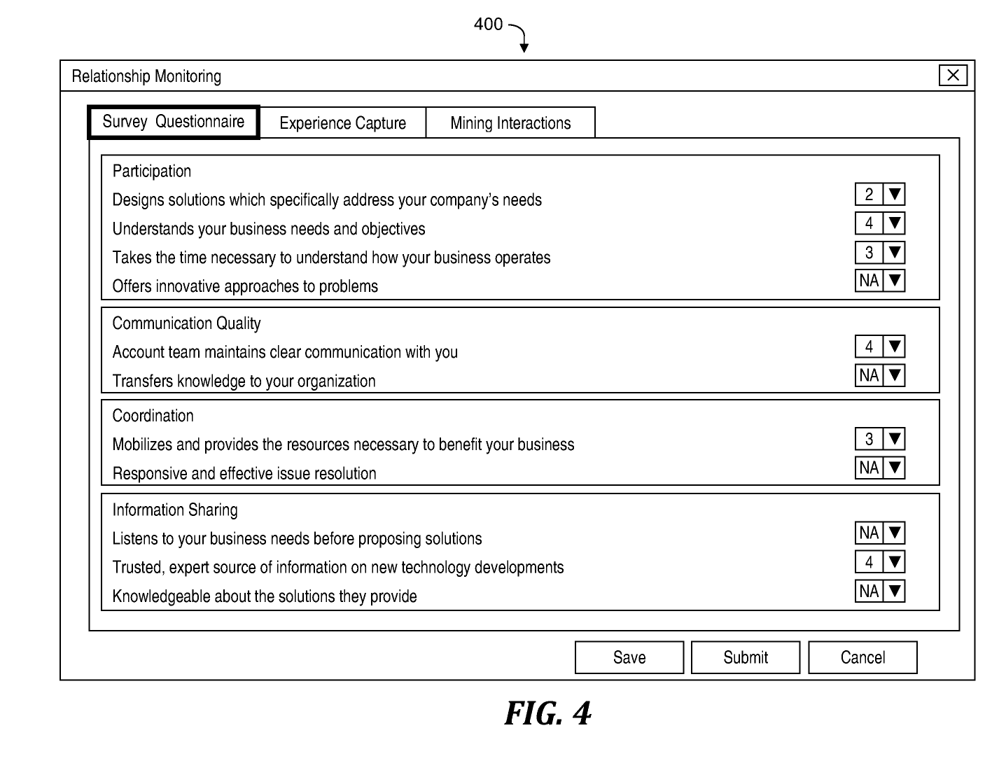

FIG. 4 is a sample interface including a survey questionnaire for identifying and monitoring factors of the relationship being modeled, monitored and assessed in the process of FIG. 2, in accordance with embodiments of the present invention. Interface 400 includes a sample role-based survey completed by a client stakeholder. The sample role-based survey classifies questionnaire statements into categories of Participation, Communication Quality, Coordination and Information Sharing. For example, in the Participation category, the client stakeholder rated how much she or he is in agreement with the statement “Designs solutions which specifically address your company's needs” by entering the value of 2 selected from the values 1 through 5.

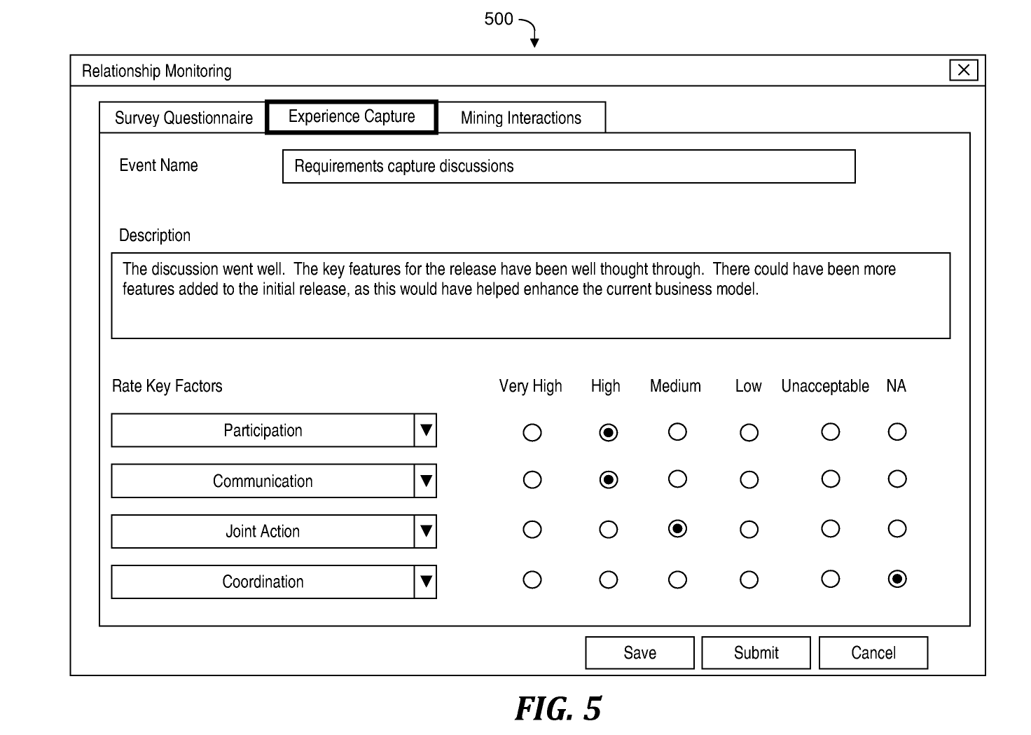

FIG. 5 is a sample interface including an experience capture form for identifying and monitoring factors of the relationship being modeled, monitored and assessed in the process of FIG. 2, in accordance with embodiments of the present invention. Interface 500 includes a sample experience capture form in which a stakeholder entered an event in the Event Name field and a description in the Description field. The description characterizes positive and negative experiences the stakeholder had relative to the event named “Requirements capture discussions.” Interface 500 also includes entries by the stakeholder that rate key factors. For example, the stakeholder indicated a “High” rating for the key factor of “Participation.”

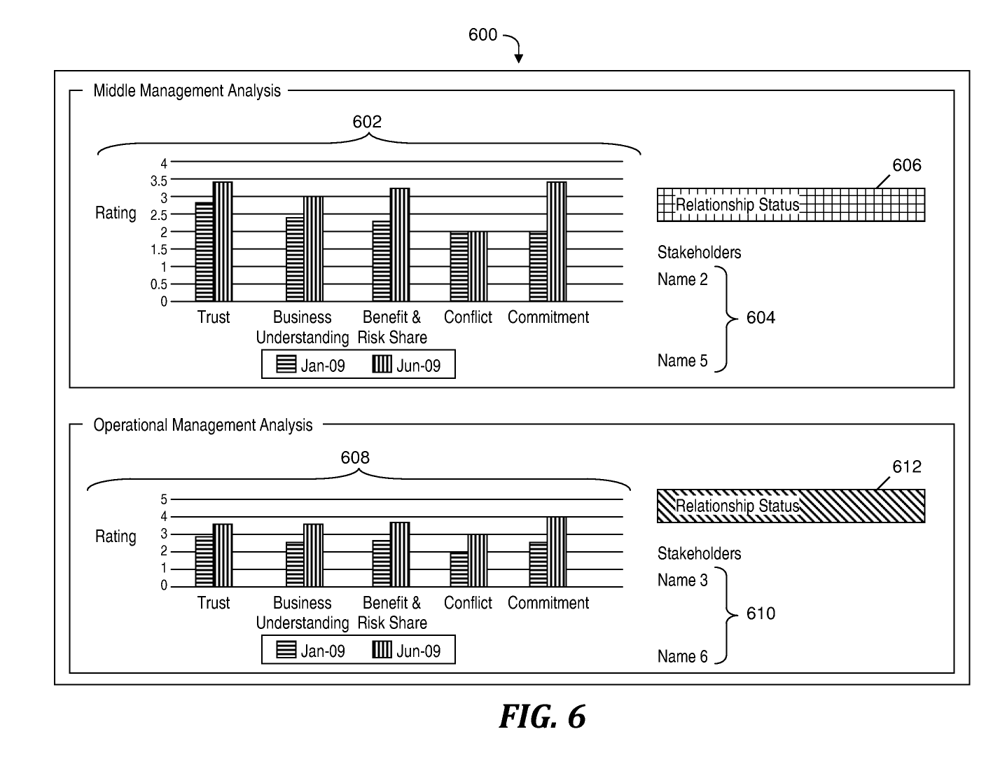

FIG. 6 is a sample report about the quality of a relationship, where the report generated in the process of FIG. 2, in accordance with embodiments of the present invention. Report 600 includes a Middle Management Analysis that includes ratings 602 at the Middle Management level. Over two time periods (i.e., January-09 and June-09), ratings 602 rate the overall trust in the relationship (i.e., Trust in report 600) and also rate relationship factors in different categories (i.e., Business Understanding, Benefit & Risk Share, Conflict and Commitment in report 600). The Middle Management Analysis includes a list of stakeholders 604 who have roles included in the Middle Management level in the provider and client organizations. The Middle Management Analysis also includes an indication of the relationship status 606 based on the ratings 602. The relationship status is represented by a yellow rectangle, where yellow is indicated by the cross-hatch fill pattern in FIG. 6. The yellow rectangle indicates that a problem with the relationship is indicated at the Middle Management level.

Report 600 also includes an Operational Management Analysis that includes ratings 608 at the Operational Management level. Over two time periods (i.e., January-09 and June-09), ratings 608 rate the overall trust in the relationship (i.e., Trust) and also rate relationship factors in different categories (i.e., Business Understanding, Benefit & Risk Share, Conflict and Commitment). The Operational Management Analysis also includes a list of stakeholders 610 who have roles included in the Operational Management level in the provider and client organizations. The Operational Management Analysis also includes an indication of the relationship status 612 based on the ratings 608. The relationship status is represented by a green rectangle, where the green is indicated by the diagonal fill pattern in FIG. 6. The green rectangle indicates that there is no problem with the relationship at the Operational Management level.

### Computer System

FIG. 7 is a block diagram of a computer system that is included in the system of FIG. 1 and that implements the process of FIG. 2, in accordance with embodiments of the present invention. Computer system 102 generally comprises a central processing unit (CPU) 702, a memory 704, an input/output (I/O) interface 706, and a bus 708. Further, computer system 102 is coupled to I/O devices 710 and a computer data storage unit 712. CPU 702 performs computation and control functions of computer system 102, including carrying out instructions included in program code 714 to perform a method of modeling, monitoring and assessing a relationship with a client, where the instructions are carried out by CPU 702 via memory 704. CPU 702 may comprise a single processing unit, or be distributed across one or more processing units in one or more locations (e.g., on a client and server). In one embodiment, program code 714 includes code for modules 106, 108, 110, 112, 114, 116 and 118 in FIG. 1.

Memory 704 may comprise any known computer-readable storage medium, which is described below. In one embodiment, cache memory elements of memory 704 provide temporary storage of at least some program code (e.g., program code 714) in order to reduce the number of times code must be retrieved from bulk storage while instructions of the program code are carried out. Moreover, similar to CPU 702, memory 704 may reside at a single physical location, comprising one or more types of data storage, or be distributed across a plurality of physical systems in various forms. Further, memory 704 can include data distributed across, for example, a local area network (LAN) or a wide area network (WAN).

I/O interface 706 comprises any system for exchanging information to or from an external source. I/O devices 710 comprise any known type of external device, including a display device (e.g., monitor), keyboard, mouse, printer, speakers, handheld device, facsimile, etc. Bus 708 provides a communication link between each of the components in computer system 102, and may comprise any type of transmission link, including electrical, optical, wireless, etc.

I/O interface 706 also allows computer system 102 to store information (e.g., data or program instructions such as program code 714) on and retrieve the information from computer data storage unit 712 or another computer data storage unit (not shown). Computer data storage unit 712 may comprise any known computer-readable storage medium, which is described below. For example, computer data storage unit 712 may be a non-volatile data storage device, such as a magnetic disk drive (i.e., hard disk drive) or an optical disc drive (e.g., a CD-ROM drive which receives a CD-ROM disk).

Memory 704 and/or storage unit 712 may store computer program code 714 that includes instructions that are carried out by CPU 702 via memory 704 to model, monitor and assess a relationship with a client. Although FIG. 7 depicts memory 704 as including program code 714, the present invention contemplates embodiments in which memory 704 does not include all of code 714 simultaneously, but instead at one time includes only a portion of code 714.

Further, memory 704 may include other systems not shown in FIG. 7, such as an operating system (e.g., Linux) that runs on CPU 702 and provides control of various components within and/or connected to computer system 102.

Storage unit 712 and/or one or more other computer data storage units (not shown) that are coupled to computer system 102 may store project/account attributes 120 (see FIG. 1), client/provider attributes 122 (see FIG. 1), results of mining project artifacts 124 (see FIG. 1), results of role-based surveys 126 (see FIG. 1), and results of project experience capture 128 (see FIG. 1).

As will be appreciated by one skilled in the art, the present invention may be embodied as a system, method or computer program product. Accordingly, an aspect of an embodiment of the present invention may take the form of an entirely hardware aspect, an entirely software aspect (including firmware, resident software, micro-code, etc.) or an aspect combining software and hardware aspects that may all generally be referred to herein as a “module”. Furthermore, an embodiment of the present invention may take the form of a computer program product embodied in one or more computer-readable medium(s) (e.g., memory 704 and/or computer data storage unit 712) having computer-readable program code (e.g., program code 714) embodied or stored thereon.

Any combination of one or more computer-readable mediums (e.g., memory 704 and computer data storage unit 712) may be utilized. The computer readable medium may be a computer-readable signal medium or a computer-readable storage medium. In one embodiment, the computer-readable storage medium is a computer-readable storage device or computer-readable storage apparatus. A computer-readable storage medium may be, for example, but not limited to, an electronic, magnetic, optical, electromagnetic, infrared or semiconductor system, apparatus, device or any suitable combination of the foregoing. A non-exhaustive list of more specific examples of the computer-readable storage medium includes: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be a tangible medium that can contain or store a program (e.g., program 714) for use by or in connection with a system, apparatus, or device for carrying out instructions.

A computer readable signal medium may include a propagated data signal with computer-readable program code embodied therein, for example, in baseband or as part of a carrier wave. Such a propagated signal may take any of a variety of forms, including, but not limited to, electromagnetic, optical, or any suitable combination thereof. A computer-readable signal medium may be any computer-readable medium that is not a computer-readable storage medium and that can communicate, propagate, or transport a program for use by or in connection with a system, apparatus, or device for carrying out instructions.

Program code (e.g., program code 714) embodied on a computer-readable medium may be transmitted using any appropriate medium, including but not limited to wireless, wireline, optical fiber cable, RF, etc., or any suitable combination of the foregoing.

Computer program code (e.g., program code 714) for carrying out operations for aspects of the present invention may be written in any combination of one or more programming languages, including an object oriented programming language such as Java®, Smalltalk, C++ or the like and conventional procedural programming languages, such as the “C” programming language or similar programming languages. Instructions of the program code may be carried out entirely on a user's computer, partly on the user's computer, as a stand-alone software package, partly on the user's computer and partly on a remote computer or entirely on the remote computer or server, where the aforementioned user's computer, remote computer and server may be, for example, computer system 102 or another computer system (not shown) having components analogous to the components of computer system 102 included in FIG. 7. In the latter scenario, the remote computer may be connected to the user's computer through any type of network (not shown), including a LAN or a WAN, or the connection may be made to an external computer (e.g., through the Internet using an Internet Service Provider).

Aspects of the present invention are described herein with reference to flowchart illustrations (e.g., FIG. 2) and/or block diagrams of methods, apparatus (systems) (e.g., FIG. 1 and FIG. 7), and computer program products according to embodiments of the invention. It will be understood that each block of the flowchart illustrations and/or block diagrams, and combinations of blocks in the flowchart illustrations and/or block diagrams, can be implemented by computer program instructions (e.g., program code 714). These computer program instructions may be provided to one or more hardware processors (e.g., CPU 702) of a general purpose computer, special purpose computer, or other programmable data processing apparatus to produce a machine, such that the instructions, which are carried out via the processor(s) of the computer or other programmable data processing apparatus, create means for implementing the functions/acts specified in the flowchart and/or block diagram block or blocks.

These computer program instructions may also be stored in a computer-readable medium (e.g., memory 704 or computer data storage unit 712) that can direct a computer (e.g., computer system 102), other programmable data processing apparatus, or other devices to function in a particular manner, such that the instructions (e.g., program 714) stored in the computer-readable medium produce an article of manufacture including instructions which implement the function/act specified in the flowchart and/or block diagram block or blocks.

The computer program instructions may also be loaded onto a computer (e.g., computer system 102), other programmable data processing apparatus, or other devices to cause a series of operational steps to be performed on the computer, other programmable apparatus, or other devices to produce a computer implemented process such that the instructions (e.g., program 714) which are carried out on the computer, other programmable apparatus, or other devices provide processes for implementing the functions/acts specified in the flowchart and/or block diagram block or blocks.

Any of the components of an embodiment of the present invention can be deployed, managed, serviced, etc. by a service provider that offers to deploy or integrate computing infrastructure with respect to modeling, monitoring and assessing a relationship with a client. Thus, an embodiment of the present invention discloses a process for supporting computer infrastructure, wherein the process comprises providing at least one support service for at least one of integrating, hosting, maintaining and deploying computer-readable code (e.g., program code 714) in a computer system (e.g., computer system 102) comprising one or more processors (e.g., CPU 702), wherein the processor(s) carry out instructions contained in the code causing the computer system to model, monitor and assess a relationship with a client.

In another embodiment, the invention provides a method that performs the process steps of the invention on a subscription, advertising and/or fee basis. That is, a service provider, such as a Solution Integrator, can offer to create, maintain, support, etc. a process of modeling, monitoring and assessing a relationship with a client. In this case, the service provider can create, maintain, support, etc. a computer infrastructure that performs the process steps of the invention for one or more customers. In return, the service provider can receive payment from the customer(s) under a subscription and/or fee agreement, and/or the service provider can receive payment from the sale of advertising content to one or more third parties.

The flowchart in FIG. 2 and the block diagrams in FIG. 1 and FIG. 7 illustrate the architecture, functionality, and operation of possible implementations of systems, methods, and computer program products according to various embodiments of the present invention. In this regard, each block in the flowchart or block diagrams may represent a module, segment, or portion of code (e.g., program code 714), which comprises one or more executable instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method of managing a relationship between a provider and a client, the method comprising the steps of:
a computer generating a first model of one or more projects in which the provider is providing a service to the client, wherein the provider and the client are business entities;
the computer generating a second model of first levels of a first organizational structure of the provider and second levels of a second organizational structure of the client;
the computer generating a third model of a first set of stakeholders having respective roles in the provider, a second set of stakeholders having respective roles in the client, and interactions between the first set of stakeholders and the second set of stakeholders;
based on the first, second and third models, the computer receiving factors that influence the relationship between the provider and the client;
the computer evaluating the received factors by receiving results of mining data from one or more artifacts of the one or more projects, surveying the provider and the client with a role-based survey, and capturing experiences provided by the provider and the client; and
based on historical information about assessments of the relationship and based on the evaluated factors, the computer assessing a status of the relationship between the provider and the client.

2. The method of claim 1, further comprising the steps of:
mining the data from the one or more artifacts of the one or more projects;
capturing the experiences provided by the provider and the client; and
the computer proactively monitoring the status of the relationship in real time by repeating the steps of mining the data from the one or more artifacts of the one or more projects and capturing the experiences provided by the provider and the client, and by repeating the step of evaluating the factors by receiving results of the repeated steps of mining the data and capturing the experiences.

3. The method of claim 1, further comprising the steps of:
the computer determining the historical information includes prior evaluations of the factors, wherein the prior evaluations are obtained by the computer prior to the step of evaluating the factors, and wherein the prior evaluations indicate an effect on the status of the relationship; and
based on the prior evaluations indicating the effect on the status of the relationship and based on the evaluated factors resulting from the step of evaluating the factors, the computer predicting the effect on the status of the relationship to occur.

4. The method of claim 1, wherein the step of generating the second model includes generating the second model representing a first level included in the first organizational structure of the provider and in the second organizational structure of the client and representing a second level included in the first organizational structure of the provider and in the second organizational structure of the client,
wherein the step of receiving factors that influence the relationship between the provider and the client includes:
receiving a first set of factors as factors that influence the relationship at the first level; and
receiving a second set of factors as factors that influence the relationship at the second level, wherein the first and second sets of factors are different,
wherein the step of evaluating the received factors includes evaluating the first and second sets of factors, and
wherein the step of assessing the status of the relationship includes:
assessing a first status of the relationship at the first level; and
assessing a second status of the relationship at the second level, wherein the first and second statuses are different.

5. The method of claim 4, further comprising the computer generating a report that includes an indication of a problem with the relationship at the first level included in the first organizational structure of the provider and in the second organizational structure of the client based on the assessed first status of the relationship at the first level and an indication of an absence of any problem with the relationship at the second level included in the first organizational structure of the provider and in the second organizational structure of the client based on the assessed second status of the relationship at the second level.

6. The method of claim 1, wherein the step of generating the third model includes generating the second model representing first stakeholders of the first and second sets of stakeholders as having a first role and representing second stakeholders of the first and second set of stakeholders as having a second role, wherein the first and second roles are different,
wherein the step of receiving factors that influence the relationship between the provider and the client includes:
receiving a first set of factors as factors that influence the relationship based on the first role; and
receiving a second set of factors as factors that influence the relationship based on the second role,
wherein the step of evaluating the received factors includes evaluating the first and second sets of factors, and
wherein the step of assessing the status of the relationship includes:
assessing a first status of the relationship based on the first role; and
assessing a second status of the relationship based on the second role, wherein the first and second statuses are different.

7. A computer system comprising:
a central processing unit (CPU);
a memory coupled to the CPU;
a computer-readable, tangible storage device coupled to the CPU, the storage device containing instructions that are carried out by the CPU via the memory to implement a method of managing a relationship between a provider and a client, the method comprising the steps of:
generating a first model of one or more projects in which the provider is providing a service to the client, wherein the provider and the client are business entities;
generating a second model of first levels of a first organizational structure of the provider and second levels of a second organizational structure of the client;
generating a third model of a first set of stakeholders having respective roles in the provider, a second set of stakeholders having respective roles in the client, and interactions between the first set of stakeholders and the second set of stakeholders;
based on the first, second and third models, receiving factors that influence the relationship between the provider and the client;
evaluating the received factors by receiving results of mining data from one or more artifacts of the one or more projects, surveying the provider and the client with a role-based survey, and capturing experiences provided by the provider and the client; and
based on historical information about assessments of the relationship and based on the evaluated factors, assessing a status of the relationship between the provider and the client.

8. The computer system of claim 7, wherein the method further comprises the steps of:
mining the data from the one or more artifacts of the one or more projects;
capturing the experiences provided by the provider and the client; and
proactively monitoring the status of the relationship in real time by repeating the steps of mining the data from the one or more artifacts of the one or more projects and capturing the experiences provided by the provider and the client, and by repeating the step of evaluating the factors by receiving results of the repeated steps of mining the data and capturing the experiences.

9. The computer system of claim 7, wherein the method further comprises the steps of:
determining the historical information includes prior evaluations of the factors, wherein the prior evaluations are performed prior to the step of evaluating the factors, and wherein the prior evaluations indicate an effect on the status of the relationship; and
based on the prior evaluations indicating the effect on the status of the relationship and based on the evaluated factors resulting from the step of evaluating the factors, predicting the effect on the status of the relationship to occur.

10. The computer system of claim 7, wherein the step of generating the second model includes generating the second model representing a first level included in the first organizational structure of the provider and in the second organizational structure of the client and representing a second level included in the first organizational structure of the provider and in the second organizational structure of the client,
wherein the step of receiving factors that influence the relationship between the provider and the client includes:
receiving a first set of factors as factors that influence the relationship at the first level; and
receiving a second set of factors as factors that influence the relationship at the second level, wherein the first and second sets of factors are different,
wherein the step of evaluating the received factors includes evaluating the first and second sets of factors, and
wherein the step of assessing the status of the relationship includes:
assessing a first status of the relationship at the first level; and
assessing a second status of the relationship at the second level, wherein the first and second statuses are different.

11. The computer system of claim 10, wherein the method further comprises the step of generating a report that includes an indication of a problem with the relationship at the first level included in the first organizational structure of the provider and in the second organizational structure of the client based on the assessed first status of the relationship at the first level and an indication of an absence of any problem with the relationship at the second level included in the first organizational structure of the provider and in the second organizational structure of the client based on the assessed second status of the relationship at the second level.

12. The computer system of claim 7, wherein the step of generating the third model includes generating the second model representing first stakeholders of the first and second sets of stakeholders as having a first role and representing second stakeholders of the first and second set of stakeholders as having a second role, wherein the first and second roles are different,
wherein the step of receiving factors that influence the relationship between the provider and the client includes:
receiving a first set of factors as factors that influence the relationship based on the first role; and
receiving a second set of factors as factors that influence the relationship based on the second role,
wherein the step of evaluating the received factors includes evaluating the first and second sets of factors, and
wherein the step of assessing the status of the relationship includes:
assessing a first status of the relationship based on the first role; and
assessing a second status of the relationship based on the second role, wherein the first and second statuses are different.

13. A computer program product, comprising a computer-readable, tangible storage device having a computer-readable program code stored therein, the computer-readable program code containing instructions that are carried out by a central processing unit (CPU) of a computer system to implement a method of managing a relationship between a provider and a client, the method comprising the steps of:
generating a first model of one or more projects in which the provider is providing a service to the client, wherein the provider and the client are business entities;
generating a second model of first levels of a first organizational structure of the provider and second levels of a second organizational structure of the client;
generating a third model of a first set of stakeholders having respective roles in the provider, a second set of stakeholders having respective roles in the client, and interactions between the first set of stakeholders and the second set of stakeholders;
based on the first, second and third models, receiving factors that influence the relationship between the provider and the client;
evaluating the received factors by receiving results of mining data from one or more artifacts of the one or more projects, surveying the provider and the client with a role-based survey, and capturing experiences provided by the provider and the client; and
based on historical information about assessments of the relationship and based on the evaluated factors, assessing a status of the relationship between the provider and the client.

14. The program product of claim 13, wherein the method further comprises the steps of:
mining the data from the one or more artifacts of the one or more projects;
capturing the experiences provided by the provider and the client; and
proactively monitoring the status of the relationship in real time by repeating the steps of mining the data from the one or more artifacts of the one or more projects and capturing the experiences provided by the provider and the client, and by repeating the step of evaluating the factors by receiving results of the repeated steps of mining the data and capturing the experiences.

15. The program product of claim 13, wherein the method further comprises the steps of:
determining the historical information includes prior evaluations of the factors, wherein the prior evaluations are performed prior to the step of evaluating the factors, and wherein the prior evaluations indicate an effect on the status of the relationship; and
based on the prior evaluations indicating the effect on the status of the relationship and based on the evaluated factors resulting from the step of evaluating the factors, predicting the effect on the status of the relationship to occur.

16. The program product of claim 13, wherein the step of generating the second model includes generating the second model representing a first level included in the first organizational structure of the provider and in the second organizational structure of the client and representing a second level included in the first organizational structure of the provider and in the second organizational structure of the client,
wherein the step of receiving factors that influence the relationship between the provider and the client includes:
receiving a first set of factors as factors that influence the relationship at the first level; and
receiving a second set of factors as factors that influence the relationship at the second level, wherein the first and second sets of factors are different,
wherein the step of evaluating the received factors includes evaluating the first and second sets of factors, and
wherein the step of assessing the status of the relationship includes:
assessing a first status of the relationship at the first level; and
assessing a second status of the relationship at the second level, wherein the first and second statuses are different.

17. The program product of claim 16, wherein the method further comprises the step of generating a report that includes an indication of a problem with the relationship at the first level included in the first organizational structure of the provider and in the second organizational structure of the client based on the assessed first status of the relationship at the first level and an indication of an absence of any problem with the relationship at the second level included in the first organizational structure of the provider and in the second organizational structure of the client based on the assessed second status of the relationship at the second level.

18. The program product of claim 13, wherein the step of generating the third model includes generating the second model representing first stakeholders of the first and second sets of stakeholders as having a first role and representing second stakeholders of the first and second set of stakeholders as having a second role, wherein the first and second roles are different,
wherein the step of receiving factors that influence the relationship between the provider and the client includes:
receiving a first set of factors as factors that influence the relationship based on the first role; and
receiving a second set of factors as factors that influence the relationship based on the second role,
wherein the step of evaluating the received factors includes evaluating the first and second sets of factors, and
wherein the step of assessing the status of the relationship includes:
assessing a first status of the relationship based on the first role; and
assessing a second status of the relationship based on the second role, wherein the first and second statuses are different.

19. A process for supporting computing infrastructure, the process comprising providing at least one support service for at least one of creating, integrating, hosting, maintaining, and deploying computer-readable code in a computer comprising a central processing unit (CPU), wherein the CPU carries out instructions contained in the code causing the computer to perform a method of managing a relationship between a provider and a client, the method comprising the steps of:
the computer generating a first model of one or more projects in which the provider is providing a service to the client, wherein the provider and the client are business entities;
the computer generating a second model of first levels of a first organizational structure of the provider and second levels of a second organizational structure of the client;
the computer generating a third model of a first set of stakeholders having respective roles in the provider, a second set of stakeholders having respective roles in the client, and interactions between the first set of stakeholders and the second set of stakeholders;
based on the first, second and third models, the computer receiving factors that influence the relationship between the provider and the client;
the computer evaluating the received factors by receiving results of mining data from one or more artifacts of the one or more projects, surveying the provider and the client with a role-based survey, and capturing experiences provided by the provider and the client; and
based on historical information about assessments of the relationship and based on the evaluated factors, the computer assessing a status of the relationship between the provider and the client.

20. The process of claim 19, wherein the method further comprises the steps of:
mining the data from the one or more artifacts of the one or more projects;
capturing the experiences provided by the provider and the client; and
the computer proactively monitoring the status of the relationship in real time by repeating the steps of mining the data from the one or more artifacts of the one or more projects and capturing the experiences provided by the provider and the client, and by repeating the step of evaluating the factors by receiving results of the repeated steps of mining the data and capturing the experiences.

21. The process of claim 19, wherein the method further comprises the steps of:
the computer determining the historical information includes prior evaluations of the factors, wherein the prior evaluations are obtained by the computer prior to the step of evaluating the factors, and wherein the prior evaluations indicate an effect on the status of the relationship; and
based on the prior evaluations indicating the effect on the status of the relationship and based on the evaluated factors resulting from the step of evaluating the factors, the computer predicting the effect on the status of the relationship to occur.

22. The process of claim 19, wherein the step of generating the second model includes generating the second model representing a first level included in the first organizational structure of the provider and in the second organizational structure of the client and representing a second level included in the first organizational structure of the provider and in the second organizational structure of the client,
wherein the step of receiving factors that influence the relationship between the provider and the client includes:
receiving a first set of factors as factors that influence the relationship at the first level; and
receiving a second set of factors as factors that influence the relationship at the second level, wherein the first and second sets of factors are different,
wherein the step of evaluating the received factors includes evaluating the first and second sets of factors, and
wherein the step of assessing the status of the relationship includes:
assessing a first status of the relationship at the first level; and
assessing a second status of the relationship at the second level, wherein the first and second statuses are different.

23. The process of claim 22, wherein the method further comprises the step of the computer generating a report that includes an indication of a problem with the relationship at the first level included in the first organizational structure of the provider and in the second organizational structure of the client based on the assessed first status of the relationship at the first level and an indication of an absence of any problem with the relationship at the second level included in the first organizational structure of the provider and in the second organizational structure of the client based on the assessed second status of the relationship at the second level.

24. The process of claim 19, wherein the step of generating the third model includes generating the second model representing first stakeholders of the first and second sets of stakeholders as having a first role and representing second stakeholders of the first and second set of stakeholders as having a second role, wherein the first and second roles are different,
wherein the step of receiving factors that influence the relationship between the provider and the client includes:
receiving a first set of factors as factors that influence the relationship based on the first role; and
receiving a second set of factors as factors that influence the relationship based on the second role,
wherein the step of evaluating the received factors includes evaluating the first and second sets of factors, and
wherein the step of assessing the status of the relationship includes:
assessing a first status of the relationship based on the first role; and
assessing a second status of the relationship based on the second role, wherein the first and second statuses are different.

25. A method of managing a relationship between a provider and a client, the method comprising the steps of:
a computer receiving attributes of one or more projects in which the provider is providing a service to the client;
the computer receiving attributes of the client and attributes of the provider;
the computer modeling the one or more projects based on the received attributes of the one or more projects;
the computer modeling an organization of the client and stakeholders associated with the client based on the received attributes of the client;
the computer modeling an organization of the provider and stakeholders associated with the provider based on the received attributes of the provider;
the computer modeling interactions among stakeholders within the client, among stakeholders within the provider, and among stakeholders across the organizations of the client and the provider;
the computer capturing information about factors that influence the relationship between the provider and the client;
the computer monitoring a status of the relationship based on the captured information;
the computer assessing the status of the relationship by applying a statistical technique to historical information about the relationship, wherein the historical information is based on the captured information about the factors that influence the relationship, and wherein the captured information includes data from stakeholders associated with the client and data from stakeholders associated with the provider; and
repeating, in real time during a life of the one or more projects, the steps of capturing the information and monitoring the status of the relationship; and
the computer re-assessing the status of the relationship by applying the statistical technique to the historical information about the relationship and additional historical information about the relationship, wherein the additional historical information is based on the captured information resulting from the step of repeating the step of capturing the information.
